(19) United States
(12) Patent Application Publication
(10) Pub. No.: US 2016/0006613 A1
(43) Pub. Date: Jan. 7, 2016

(54) DETECTING AN ACCESS CUSTOMER EDGE DEVICE OF A PROVIDER EDGE DEVICE

(71) Applicant: HANGZHOU H3C TECHNOLOGIES CO., LTD., Hangzhou, Zhejiang (CN)

(72) Inventors: Feihong DONG, Beijing (CN); Xiang SHI, Beijing (CN); Xiaodong LI, Beijing (CN)

(21) Appl. No.: 14/768,702

(22) PCT Filed: Dec. 2, 2013
(86) PCT No.: PCT/CN2013/088279

§ 371 Date: Aug. 18, 2015

(30) Foreign Application Priority Data
Mar. 18, 2013 (CN) 201310086887.6

(51) Int. Cl. H04L 12/24; H04L 12/857; H04L 12/723; H04L 12/46

(52) U.S. Cl. CPC H04L 41/0816; H04L 12/4658; H04L 12/4633; H04L 47/2491; H04L 45/50

(57) ABSTRACT

According to an example, a Virtual Switch Instance (VSI) in a provider edge (PE) device is obtained and an encapsulation Virtual Local Area Network (VLAN) ID corresponding to the VSI is obtained. A service VLAN (SVLAN) ID in VLAN mapping information in a customer edge (CE) device adjacent to the PE device in the VSI is also obtained, and the CE device is determined to be an access CE device of the PE device in the VSI in response to a determination that the SVLAN ID is identical to the encapsulation VLAN ID.

### BACKGROUND

In a remote connection network structure of a Multi-Protocol Label Switch (MPLS) Layer 2 Virtual Private Network (L2VPN), layer 2 data is transparently transmitted in a uniform MPLS or Internet Protocol (IP) backbone network which cannot be perceived by users. For users, it seems like nodes are directly connected with one another via Ethernet links. At present, a network management system of an MPLS L2VPN performs automatic detection. A VPN is detected by reading Virtual Switch Instance (VSI) configuration information in a provider edge (PE) by a visiting device.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating a structure of a remote connection network of MPLS L2VPN;

FIG. 2 is a flowchart illustrating a method for detecting an access CE device of a PE device according to an example of the present disclosure;

FIG. 3 is a flowchart illustrating a method for detecting an access CE device of a PE device in an application scenario according to an example of the present disclosure;

FIG. 4A is a schematic diagram illustrating obtaining an encapsulation VLAN ID by using command lines according to an example of the present disclosure;

FIG. 4B-4D are schematic diagrams illustrating obtaining an SVLAN ID by using command lines according to an example of the present disclosure;

FIG. 5 is a schematic diagram illustrating modules for detecting an access CE device of a PE device according to an example of the present disclosure; and

FIG. 6 is a schematic diagram illustrating a structure of an apparatus for detecting an access CE device of a PE device according to an example of the present disclosure.

### DETAILED DESCRIPTIONS

For simplicity and illustrative purposes, the present disclosure is described by referring to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. Quantities of an element, unless specifically mentioned, may be one or a plurality of, or at least one.

Examples of the present disclosure provide technical schemes for detecting an access CE device of a PE device which is applicable to an MPLS L2VPN composed of CE devices and PE devices.

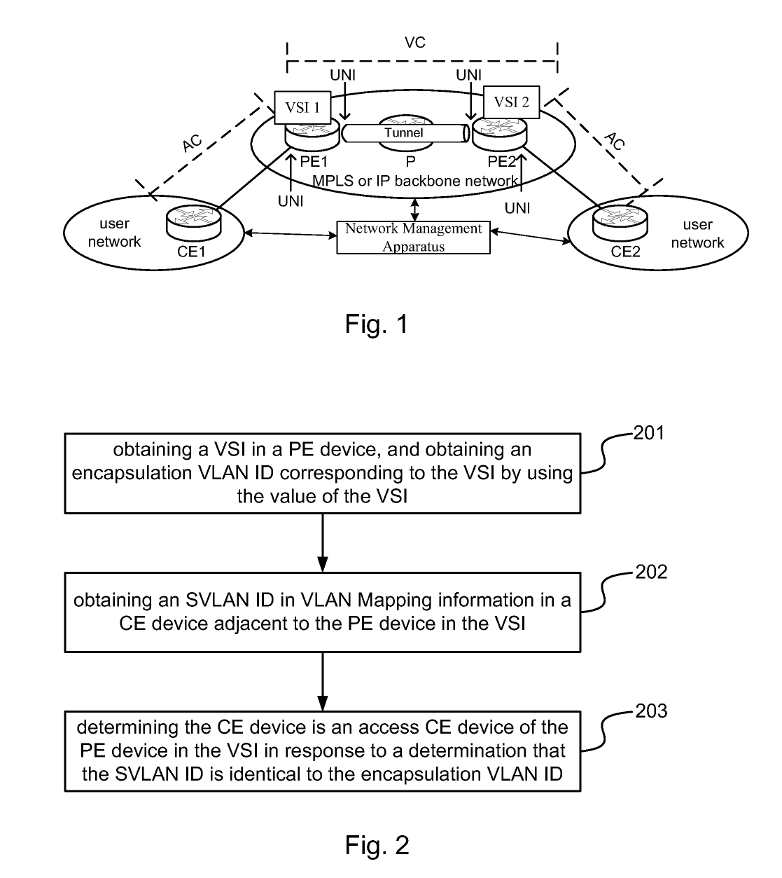

FIG. 1 is a schematic diagram illustrating a structure of a remote connection network of MPLS L2VPN. In order to transport layer 2 user packets between CE devices across the backbone network, public tunnels are established to bear Virtual Circuits (VC), User Network Interfaces (UNI) are configured in PE devices to establish Attachment Circuits (AC), and layer 3 Network Node Interfaces (NNC) are configured to establish VC connections and thus bind the AC with the VC.

According to an example, automatic detection of an access CE device of a PE device in an MPLS L2VPN may be performed. For example, VSI 1 is in PE 1. For example, the network management apparatus, which may be a network management server, may obtain information for VSIs in PE 1, such as identifying VSI 1 in PE 1. The network management apparatus may communicate with PE 1 and other PE devices and CE devices via a network to obtain the desired information. The network management apparatus obtains an encapsulation Virtual Local Area Network (VLAN) ID corresponding to VSI 1 by using the value of the VSI 1, and obtains a Service VLAN (SVLAN) ID in VLAN mapping information of a CE 1 which is adjacent to PE 1. The network management apparatus determines CE 1 is an access CE device of PE 1 in the VSI 1 in response to a determination that the SVLAN ID is identical to the encapsulation VLAN ID. The same procedure may be performed to determine CE 2 is an access CE device of PE 2 for VSI 2. An example of the network management apparatus is further described with respect to FIG. 6.

FIG. 2 is a flowchart illustrating a method for detecting an access CE device of a PE device according to an example of the present disclosure. The method may include the following procedures.

At block 201, a VSI in a PE device is obtained, and an encapsulation VLAN ID corresponding to the VSI is obtained by using the value of the VSI.

In an example, all VSIs in the PE device may be obtained by using command lines, and an encapsulation VLAN corresponding to each VSI may be obtained by using the value of the VSI.

At block 202, an SVLAN ID in VLAN mapping information in a CE device adjacent to the PE device in the VSI is obtained.

In an example, the CE device adjacent to the PE device in a VSI may be determined based on layer 2 topology and CEs whose information has been imported into the network management system.

An application policy, e.g., a quality of service (QoS) policy, configured for the incoming traffic (i.e., in the ingress direction) of a customer-side port (i.e., a downlink port) of a CE device adjacent to the PE device in a VSI may be obtained, and traffic behavior defined by using the QoS policy may also be obtained. The SVLAN ID configured for the traffic behavior may be obtained by using the traffic behavior obtained.

There may be multiple VSIs in the PE device. In this case, an SVLAN ID in VLAN mapping information of a CE device adjacent to the PE device in each VSI may be obtained respectively.

Correspondingly, there may be multiple CE devices that are adjacent to the PE device in a VSI. In this case, an SVLAN ID in VLAN mapping information of each CE device adjacent to the PE device in the VSI may be obtained respectively.

At block 203, it is determined the CE device is an access CE device of the PE device in the VSI in response to a determination that the SVLAN ID is identical to the encapsulation VLAN ID.

In an example, after the encapsulation VLAN ID corresponding to the VSI of the PE device and the SVLAN ID in the VLAN mapping information of the CE device adjacent to the PE device in the VSI are obtained, it is determined whether the SVLAN ID is identical to the encapsulation VLAN ID to determine whether the CE device is the access CE device of the PE device in the VSI. It is determined the CE device is the access CE device of the PE device in the VSI in response to a determination that the SVLAN ID is identical to the VLAN ID.

The technical scheme is further illustrated by referring to certain specific application scenario to make the technical scheme more apparent.

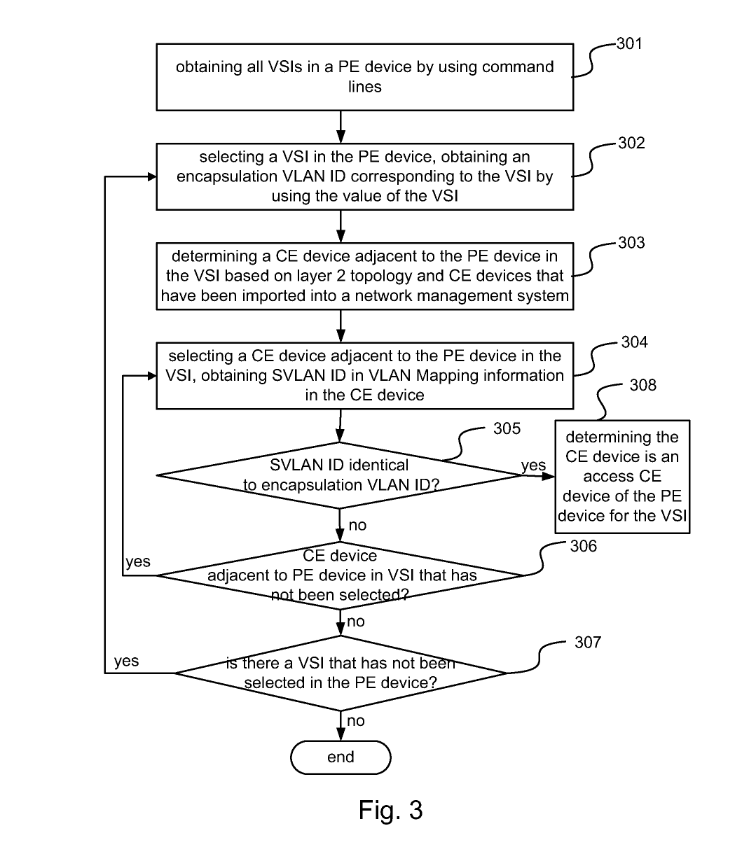

FIG. 3 is a flowchart illustrating a method for detecting an access CE device of a PE device in an application scenario according to an example of the present disclosure. The method may include the following procedures.

At block 301, all VSIs in a PE device are read in by using command lines.

At block 302, a VSI in a PE device is selected, and an encapsulation VLAN ID corresponding to the VSI is obtained by using the value of the VSI.

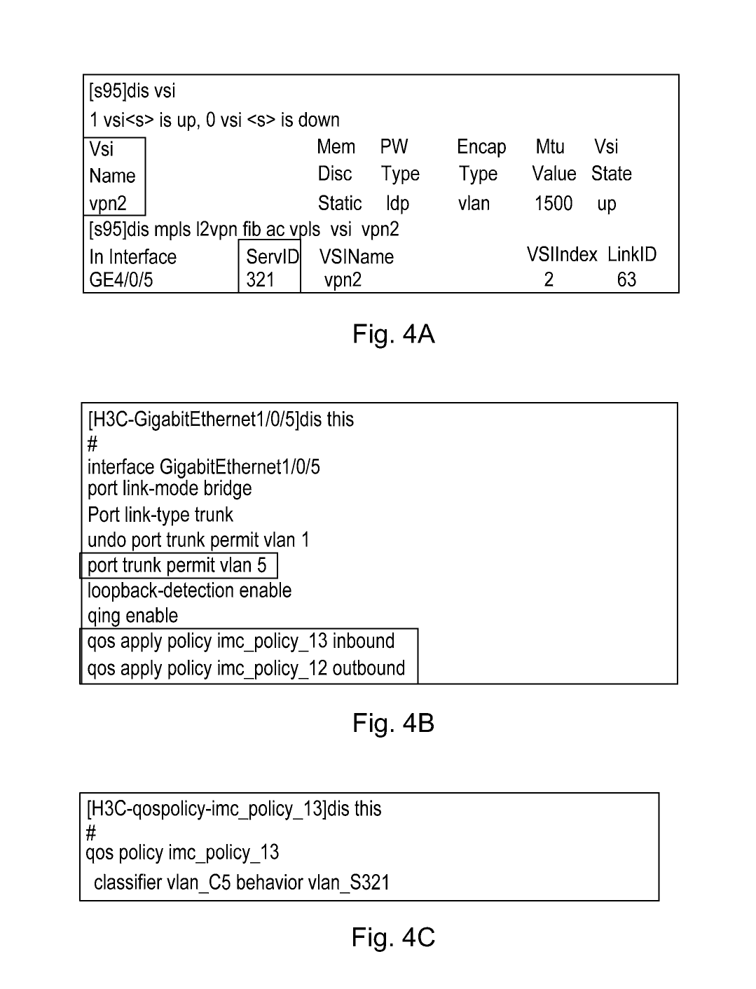

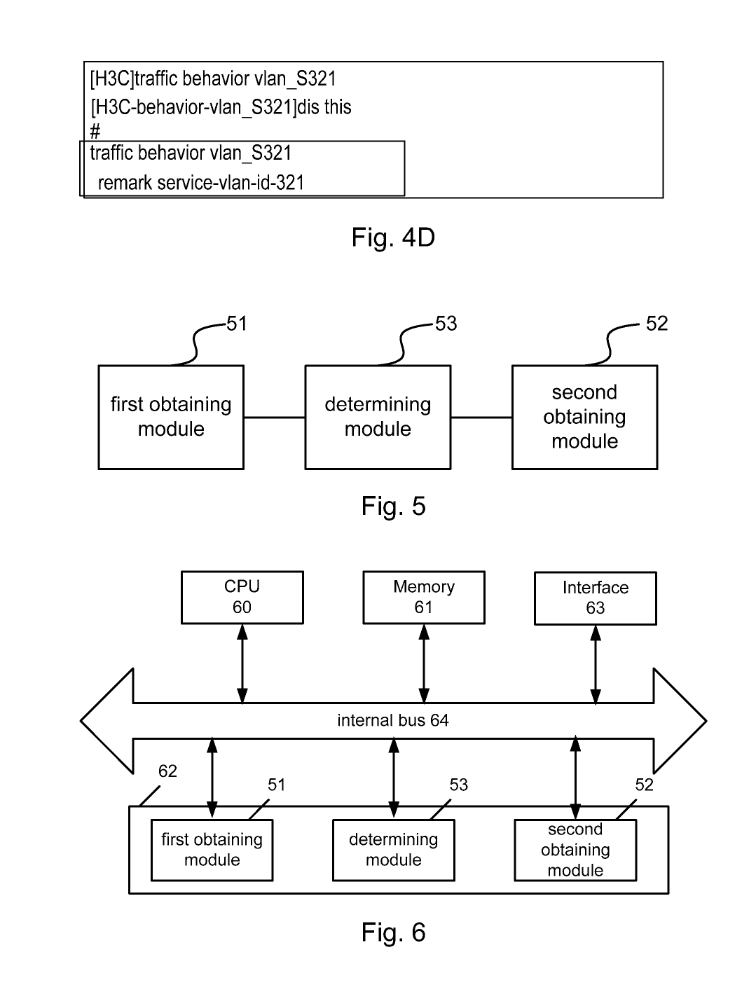

In this example, a PE device which has only one VSI is taken as an example to simplify the description. The value of the VSI is “vpn2”. As shown in FIG. 4A, the encapsulation VLAN ID (i.e., “321”) corresponding to the VSI may be obtained by using command lines.

At block 303, CE devices adjacent to the PE device in the VSI are determined based on layer 2 topology and CE devices that have been imported into the network management system.

Suppose in the example, the number of CE devices adjacent to the PE device in VSI “vpn2” is 2 (CE1 and CE2).

At block 304, a CE device adjacent to the PE device in the VSI is selected, and an SVLAN ID in VLAN mapping information in the CE device is obtained.

Taking CE1 as an example, as shown in FIG. 4B, 4C and 4D, by using command lines, an QoS policy (“imc_policy_{—}13”) configured for the incoming traffic of the customer-side port of the CE device may be obtained, a traffic behavior (“vlan_S321”) defined by the QoS policy may be obtained, and an SVLAN ID (“321”) corresponding to the traffic behavior “vlan_S321” may be obtained.

At block 305, a determination is made as to whether the SVLAN ID is identical to the encapsulation VLAN ID. If yes, at block 308, it is determined the CE device is an access CE device of the PE device in the VSI.

In the example, since the SVLAN ID in the VLAN mapping information of CE1 and the encapsulation VLAN ID corresponding to VSI “vpn2” are both “321”, it is determined that CE1 is the access CE device of the PE device in VSI “vpn2”.

If the determination at block 305 is no (i.e., the SVLAN ID is not identical to the encapsulation VLAN ID), at block 306, the PE device determines whether there is a CE device adjacent to the PE device in the VSI that has not been selected. If yes, processing returns to block 304 for the next CE device that is adjacent to the PE device in the VSI.

In the example, since the PE device has another adjacent CE device CE2 in VSI “vpn2”, it is further determined whether CE2 is an access CE device of the PE device in VSI “vpn2”.

If the determination at block 306 is no (i.e., there are no more CE devices adjacent to the PE device that have not been selected), at block 307, the PE device determines whether there is a VSI that has not been selected. If yes, the processing returns to block 302 for the next VSI. Otherwise, the method is terminated in response to a determination that there is no VSI that has not been selected.

In this example, since the PE device has only one VSI, after automatic detection of an access CE device in VSI “vpn2” is performed, the method is terminated.

In an example, the above process may be automatically implemented by a machine according to pre-defined machine readable instructions executed by a processor. The method may be implemented in the background.

The technical scheme implements automatic detection of an access CE device of a PE device in an MPLS L2VPN by obtaining a VSI in a PE device, obtaining an encapsulation Virtual Local Area Network (VLAN) ID corresponding to the value of the VSI, obtaining a Service VLAN (SVLAN) ID in VLAN mapping information of a CE device adjacent to the PE device, and determining the CE device is an access CE device of the PE device in the VSI in response to a determination that the SVLAN ID is identical to the encapsulation VLAN ID.

Based on the above concept, various examples of the present disclosure also provide an apparatus for detecting an access CE device of a PE device which can implement the above method.

FIG. 5 is a schematic diagram illustrating modules of an apparatus for detecting an access CE device of a PE device according to an example of the present disclosure. The modules may include machine readable instructions stored on a non-transitory medium and executable by a processor to perform the methods and functions described herein. The modules may be in an apparatus in an MPLS L2VPN composed of CE devices and PE device, and may include the following components.

A first obtaining module 51 obtains a VSI in a PE device, and obtains an encapsulation VLAN ID corresponding to the VSI by using the value of the VSI.

A second obtaining module 52 obtains an SVLAN ID in VLAN mapping information in a CE device adjacent to the PE device.

A determining module 53 determines the CE device is an access CE device of the PE device in the VSI in response to a determination that the SVLAN ID is identical to the encapsulation VLAN ID.

The second obtaining module 52 may obtain an SVLAN ID in VLAN mapping information in an adjacent CE device in each VSI respectively when the PE device has multiple VSIs.

The second obtaining module 52 may obtain an SVLAN ID in VLAN mapping information in each adjacent CE device in an VSI respectively when the PE device has multiple adjacent CE devices in the VSI.

The second obtaining module 52 may obtain the SVLAN ID in the VLAN mapping information in the CE device adjacent to the PE device in the VSI by: obtaining an QoS policy configured for the incoming traffic of the customer-side port of the CE device, obtaining a traffic behavior defined by the QoS policy; and obtaining the SVLAN ID configured for the traffic behavior by using the traffic behavior.

FIG. 6 is a schematic diagram illustrating a structure of an apparatus for detecting an access CE device of a PE device according to an example of the present disclosure. The apparatus may be in an MPLS L2VPN composed of CE devices and PE device. The apparatus may include the first obtaining module 51, the second obtaining module 52, the determining module 53 stored in a non-transitory computer readable medium 62. The non-transitory computer readable medium 62 may be memory 61 and/or non-volatile data storage. A CPU 60 may execute the machine readable instructions of the modules 51-53 and the components shown in FIG. 6 may be connected via internal bus 64. Interface 63 may be used to communicate with external devices and may include a network interface.

The CPU 60 performs calculations of data. The memory 61 stores various types of data, e.g., intermediate data of a calculation and a calculation result, information obtained from a PE device and from a CE device, and so on. The internal bus 64 implements information interactions between the components, and may be a bus or a collection of multiple wired or wireless links.

The apparatus shown in FIG. 6 may be in a network management server, or in one or multiple standalone devices. When the apparatus is in a network management server, the network management server may communicate with a PE device and a CE device by using a conventional manner (e.g., Telnet and the like). When the apparatus is a standalone device, various conventional communication methods may be adopted to connect the apparatus with the PE device and the CE device.

It should be understood that in the above processes and structures, not all of the procedures and modules are necessary. Certain procedures or modules may be omitted according to the needs. The order of the procedures is not fixed, and can be adjusted according to the needs. Those skilled in the art can understand the modules 51-53 in the apparatus of FIG. 6 may be located in the apparatus as described in the embodiments, or may be located in one or more apparatuses. The modules 51-53 may be combined into one module, or may be further divided into multiple sub modules.

Through the above description, those skilled in the art may understand that the examples of the present disclosure may be implemented by hardware or by a hardware platform together with software including machine readable instructions stored in a non-transitory storage medium. Thus, the examples may be embodied by a software product.

In various examples, the hardware may be implemented by dedicated hardware or hardware executing machine readable instructions. For example, the hardware may comprise dedicated circuitry or logic that is permanently configured (e.g., as a special-purpose processor, such as a field programmable gate array (FPGA) or an application-specific integrated circuit (ASIC)) to perform certain operations. The hardware may also comprise programmable logic or circuitry (e.g., as encompassed within a general-purpose processor or other programmable processor) that is temporarily configured by software to perform certain operations.

Machine readable instructions for the modules 51-53 shown in FIG. 6 may cause an operating system running in a computer to implement part or all of the operations described herein. In addition, the non-transitory computer readable medium 62 may be a storage device in an extension board inserted in the computer or a storage in an extension unit connected to the computer. In this example, a CPU in the extension board or the extension unit executes at least part of the operations according to the instructions.

The non-transitory computer readable medium 62 may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

The scope of the claims should not be limited by the embodiments set forth in the examples, but should be given the broadest interpretation consistent with the description as a whole.

1. A method to detect a customer edge (CE) device adjacent to a provider edge (PE) device in a Virtual Switch Instance (VSI) in a Multi-Protocol Label Switch (MPLS) Layer 2 Virtual Private Network (L2VPN), the method comprising:
obtaining the VSI in the PE device;
obtaining an encapsulation Virtual Local Area Network (VLAN) ID corresponding to the VSI;
obtaining a service VLAN (SVLAN) ID in VLAN mapping information in the CE device adjacent to the PE device in the VSI; and
determining the adjacent CE device is an access CE device of the PE device in the VSI in response to a determination that the SVLAN ID is identical to the encapsulation VLAN ID.

2. The method of claim 1, wherein the PE device has multiple VSIs, and obtaining the SVLAN ID in the VLAN mapping information in the CE device adjacent to the PE device in the VSI comprises:
for each of the multiple VSIs, obtaining an SVLAN ID in VLAN mapping information in a CE device adjacent to the PE device.

3. The method of claim 1, wherein the PE device has multiple adjacent CE devices in the VSI, and obtaining an SVLAN ID in VLAN mapping information in a CE device adjacent to the PE device in each VSI comprises:
obtaining an SVLAN ID in VLAN mapping information in each adjacent CE device.

4. The method of claims 1, wherein obtaining the SVLAN ID in the VLAN mapping information in the CE device adjacent to the PE device in the VSI comprises:
obtaining a QoS policy configured for an ingress direction of a downlink port of the adjacent CE device;
obtaining a traffic behavior defined by the QoS policy; and
obtaining an SVLAN ID configured for the traffic behavior by using the traffic behavior.

5. An apparatus to detect a customer edge (CE) device adjacent to a provider edge (PE) device in a Virtual Switch Instance (VSI) in a Multi-Protocol Label Switch (MPLS) Layer 2 Virtual Private Network (L2VPN), the apparatus comprising:
a processor;
a first obtaining module, executed by the processor, to obtain the VSI in the PE device, and obtain an encapsulation Virtual Local Area Network (VLAN) ID corresponding to the VSI;
a second obtaining module, executed by the processor, to obtain a service VLAN (SVLAN) ID in VLAN mapping information in the CE device adjacent to the PE device; and
a determining module, executed by the processor, to determine the adjacent CE device is an access CE device of the PE device in the VSI in response to a determination that the SVLAN ID is identical to the encapsulation VLAN ID.

6. The apparatus of claim 5, wherein the PE device has multiple VSIs, and, for each of the multiple VSIs, the second obtaining module is to obtain an SVLAN ID in VLAN mapping information in a CE device adjacent to the PE device.

7. The apparatus of claim 6, wherein the PE device has multiple adjacent CE devices in the VSI, and
the second obtaining module is to obtain an SVLAN ID in VLAN mapping information in each adjacent CE device.

8. The apparatus of any of claims 5, wherein the second obtaining module is to obtain the SVLAN ID in the VLAN mapping information in the CE device adjacent to the PE device in the VSI by:
obtaining a QoS policy configured for an ingress direction of a downlink port of the adjacent CE device, obtaining a traffic behavior defined by the QoS policy; and
obtaining an SVLAN ID configured for the traffic behavior by using the traffic behavior.
